(19) United States
(12) Patent Application Publication
(10) Pub. No.: US 2016/0044899 A1
(43) Pub. Date: Feb. 18, 2016

(54) ARTIFICIAL REEF

(71) Applicant: Michael BARTKOWSKI, Pensacola, FL (US)

(72) Inventor: Michael Scott Bartkowski, Pensacola, FL (US)

(21) Appl. No.: 14/776,823

(22) PCT Filed: Mar. 17, 2014
(86) PCT No.: PCT/IB2014/059912

§ 371 Date: Sep. 15, 2015

Related U.S. Application Data
(60) Provisional application No. 61/800,367, filed on Mar. 15, 2013.

(51) Int. Cl. A01K 61/00

(52) U.S. Cl. CPC A01K 61/006

(57) ABSTRACT

An artificial reef provides a system that can inhibit coastal erosion, promote marine growth and offer shelter to marine life while being economically feasible and long-lasting. Various embodiments of the artificial reef unit devices and methods described herein can include three polygonal side walls, an enclosed top and an opened bottom, a base unit and corrugated walls.

### CROSS-REFERENCE TO RELATED APPLICATIONS

This application claims priority from U.S. Provisional Patent Application Ser. No. 61/800,367, filed Mar. 15, 2013, the disclosure of which is hereby incorporated by reference in its entirety.

### STATEMENT REGARDING FEDERALLY SPONSORED RESEARCH OR DEVELOPMENT

Not Applicable.

### BACKGROUND

1. Field

The disclosed subject matter is generally directed to artificial reefs, and more particularly, to structures and methods that can lessen the erosion of beaches and shorelines, promote marine growth and provide protection and shelter for marine life. The disclosed subject matter also provides methods of fabricating versatile structures that can be used as artificial reefs in fresh or salt water and can be used as barriers in various applications when the structure is located above water and on the ground.

2. Description of Related Art

Various types and configurations of reef systems are known. For example, U.S. Pat. No. 5,564,369 discloses a circular reef system having a plurality of orifices extending therethrough. Though this system may be successful for a short time, it is questionable as to this system's longevity and stability. The round, circular shape appears to be of a shape that will and can promote movement with a natural current or even tidal currents generally associated with normal current flow. Movement may cause destruction of the artificial reef, consequently defeating its intended purpose.

Another artificial reef is disclosed in U.S. Pat. No. 5,080,526, which discloses an erosion protection unit having a tetrahedral frame comprising six outer elongated members arranged in an outline of a tetrahedron, and a triaxial central strut arrangement. Although this device may promote marine growth, this device fails to offer the needed housing and protection necessary to sustain marine life.

Although there have been several types of artificial reefs, none of them have become sufficiently compact, low cost, and reliable enough to become commonly used. Accordingly, what is needed is an artificial reef that meets the need for simplified design, compact size, low initial cost, low operating cost, ease of installation and ease of maintainability.

### SUMMARY

An artificial reef embodying the principles disclosed herein can provide a system that can inhibit coastal erosion, promote marine growth and offer shelter to marine life while being economically feasible and long-lasting.

Various embodiments of the artificial reef unit devices and methods described herein can include three polygonal side walls, an enclosed top and an opened bottom. When deployed, this opened bottom can contact and engage the sea bottom.

In an embodiment, extending through each side wall is at least one opening. The at least one opening can be of the shape and size to add increased stability to the device, to provide smooth current flow and dispersion of current forces, and to enable light to extend into the interior of the unit. This can provided several benefits to the disclosed embodiments including, but not limited to: maintaining the structure in a secured position even through strong water currents and wave conditions; permit more exposure of sunlight into the device and allow a constant exposure to micro-nutrient rich water to inherently promote quicker marine growth and prevent stagnant water; and enable habitat for any array of marine life, regardless of size, and to allow for easing movement in and out of the structure. In addition, to promote this smooth flow, the openings can be tapered.

In an embodiment, optionally, the unit can include shelves, attached either interiorly or exteriorly. These added shelves can provide additional habitat for those species, such as grouper, for example, that prefer overhead shelter or for the attachment of lobster bins. When using lobster bins, they are generally secured along the bottom of the haven.

In an embodiment, the three-sided wall extends upward and inward from the opened bottom to the enclosed top. This can provide for the walls to be angularly disposed. Such an arrangement can provide a better opportunity for invertebrates to attach given the flow pattern around and through the structure. In addition, the structure can create a smoother interaction, should it occur, between the artificial reef and fishing nets and thus prevent snags and entanglements when there is contact.

Angling the walls can provide for an overall smooth surface. This particular positioning can reduce fluid flow turbulence thereby increasing and enhancing juvenile corals' ability to attach and develop into mature coral.

In an embodiment, the upper wall can be triangular in shape and contacts the three planar side walls. A through hole can extend through this upper wall to offer yet another passage for marine life to explore and to add to stability by permitting fluid flow and reducing upward lifting forces.

In an embodiment, an artificial reef can be any size or shape to provide for a structure that is designed and configured to a particular environment. In addition, the smaller scale reef can be located within a larger scale reef to add more dimension and interest to the overall structure and consequently providing for a balanced reef system.

In an embodiment, the elements and components can be fabricated from steel reinforced concrete to provide for a unit that is structurally sound and long-lasting, even when exposed to harsh elements. For example, the natural texture of the concrete can promote invertebrate growth and enable attachment thereto.

In an embodiment, the method of fabricating an artificial reef can include the steps of providing an inner mold portion. Surrounding the inner mold portion can be a structural frame member formed of re-bar. This frame member can reinforce the final artificial reef structure, adding to its stability and durability.

In an embodiment, removable opening members can be secured to the inner mold member. An outer mold member can be placed over and around the inner mold member. A sealing means can secure the inner member to the outer member for enabling the opening members to contact both the inner mold and the outer mold. This can allow for the windows to form.

In an embodiment, cement, or the like, can be inserted between the inner and outer members for forming the artificial reef units. Additives can be added to the cement, or the like, for enhancing the final product. Once the cement is cured, the outer member can be removed, the opening members can be removed, and the formed artificial reef can be removed. The design and configuration of the final product provides for an artificial reef which can stacked, rendering a compact and efficient mode of transporting and storing the finished product.

Various embodiments described herein can provide for an artificial reef that can overcome the deficiencies, shortcomings, and drawbacks of prior artificial reefs and methods thereof. These artificial reefs can stand alone or in groups or arrays and can include an adequate amount of surface area to promote and enable marine growth.

The embodiments described herein can provide a versatile artificial reef device that can conform to conventional forms of manufacture and be of simple construction and easy to use so as to provide a device that can be economically feasible, long-lasting and relatively trouble free in operation.

The embodiments described herein can meet need for simplified design, compact size, low initial cost, low operating cost, ease of installation and maintainability, and minimal amount of training to successfully employ them.

### BRIEF DESCRIPTION OF THE DRAWINGS

As will be realized, different embodiments are possible, and the details disclosed herein are capable of modification in various respects, all without departing from the scope of the claims. Accordingly, the drawings and descriptions are to be regarded as illustrative in nature and not as restrictive. Like reference numerals or characters are used throughout the several views and embodiments to designate like components.

FIG. 1 shows a perspective view of an embodiment of an artificial reef.

FIG. 2 is a perspective view of an embodiment of an artificial reef.

FIG. 2a is a perspective view of an embodiment of an artificial reef.

FIG. 2b is a perspective view of an embodiment of several artificial reef units.

FIG. 3 is a perspective view of an accessory that can be used with an embodiment of an artificial reef.

FIG. 4a is a perspective view of an accessory that can be used with an artificial reef embodiment.

FIG. 4b is a perspective view of the accessory illustrated in FIG. 4a placed next to an artificial reef embodiment.

FIG. 5 is a side view of another embodiment of an artificial reef illustrating a smaller version of an artificial reef located inside a larger artificial reef.

FIGS. 6-6e are views of components utilized for forming various embodiments of an artificial reef unit.

FIGS. 7-7j are views showing embodiments of an artificial reef unit with a corrugated design.

FIGS. 8a-8c are views showing embodiments of artificial reef units placed in the water.

### DETAILED DESCRIPTION

To facilitate an understanding of the principles upon which the subject matter disclosed herein is based, illustrative embodiments are described hereinafter with reference to their implementation as an artificial reef. It will be appreciated that the practical applications of these principles are not limited to this particular type of system. Rather, they can be equally employed in any other type of system that can provide for inhibiting shoreline erosion, promoting marine growth and offering shelter to marine life.

U.S. Pat. No. 6,186,702 is incorporated by reference herein.

As used in this application, artificial reef, artificial reef unit, reef unit and wave attenuation device (WAD) or WAD unit can be used interchangeably.

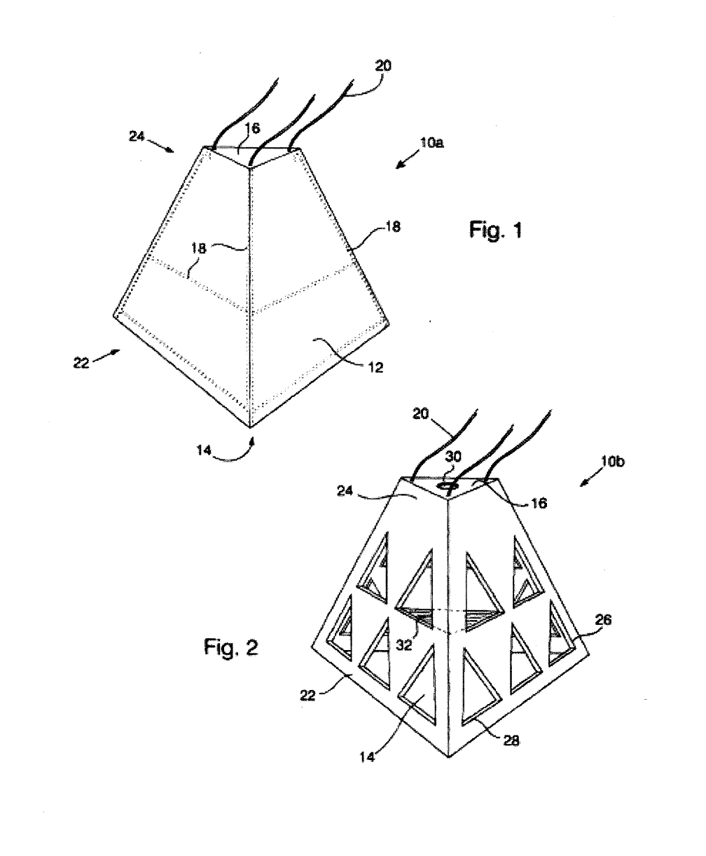

With reference to the drawings, illustrative embodiments will be described. As seen in FIG. 1, artificial reef unit 10a is shown to include side walls 12, an opened bottom 14 and an enclosed top 16. The walls 12 can be sloped inward from the opened bottom 14 to the enclosed top 16. This can give an overall shape of artificial reef 10a to be a substantially vertical structure wherein the top is smaller in surface and overall size than the bottom. As seen in this figure, the structure 10a can include three walls which can inherently form a substantially pyramidal shape. Such a design of having a top which is smaller than the bottom can offer a final product with several advantages. One advantage is that this type of configuration can provide for a unit which can be transported and stored efficiently, by enabling a subsequent reef to be stacked on top of a preceding reef. Yet another advantage is that this increased size in the bottom will consequently increase the size of the base for providing a unit that can be stable and functional, regardless of its environment or intended use.

In addition, if the final product is a geometric shape, the preceding artificial reef can be placed right side up, while the subsequent artificial reef can be placed adjacent to the preceding reef in an upside down position. Thus, the base of the preceding artificial reef can be in contact with the particular surface, while the top portion of the subsequent artificial reef can be in contact with the particular surface. This can provide for a plurality of reefs to form an elongated barrier.

For added ease of transportability, a carrying means 20 can be provided on the enclosed top 16. As seen in this figure, the carrying means can include ropes, which optionally can be tied together to form a loop. This carrying means 20 can enable a hitch or the like to easily lift and transport unit 10a to any given location or destination.

In an embodiment, the inclination of the walls can provide a device having a lower portion 22 that is larger in width and length than that of the upper portion 24. Such an arrangement can provide for a device that is sturdy and which can be inherently heavier at the base. This weighted bottom can be beneficial when used in water, since its weighted base will inherently embed itself into the sea bottom for affixing the artificial reef in a secure position.

In addition, angling the walls can provide for an overall smooth structure. This particular positioning can reduce fluid flow turbulence, thereby helping to increase and enhance the ability of juvenile coral to attach and develop into mature coral.

To increase the structural strength of various embodiments, a reinforced frame 18 (illustrated in outline) can be embedded into the device. The reinforcement can occur on each corner, adding to its stability. Optionally, and as is illustrated, the reinforced frame can be located horizontally across each wall 12.

An artificial reef unit embodiment 10a can be ideal for use in or out of water. For example, the embodiment shown can be well-suited for use out of water and on the ground, by providing an article that can be used as a barrier. Barriers can be used in various applications, such as military use, beach and sand dune restoration, or the like, to name a few non-limiting examples.

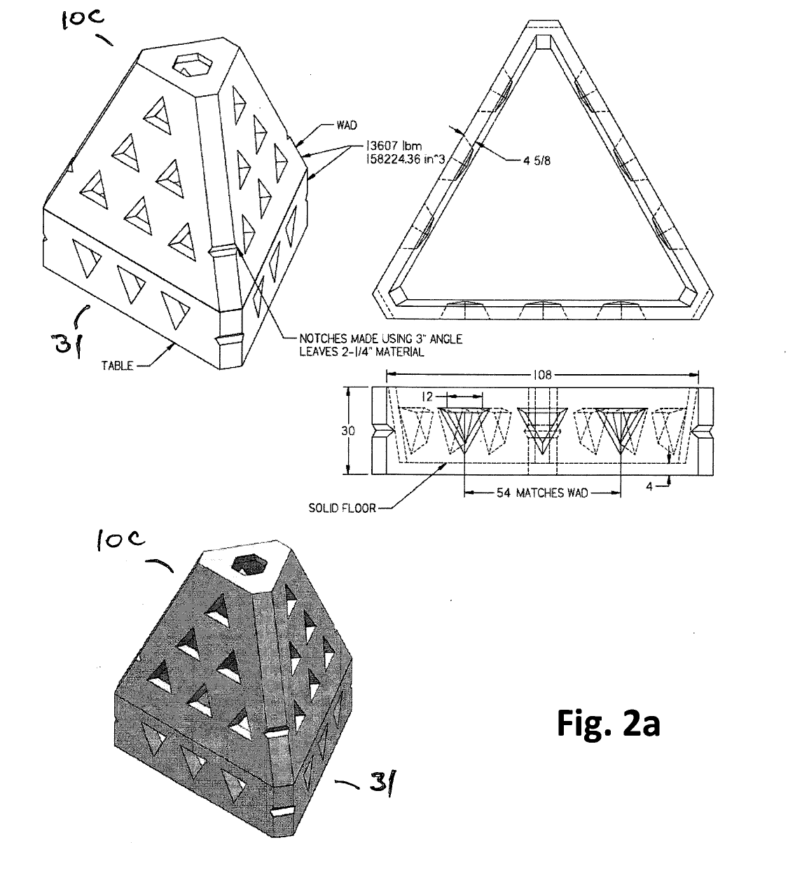

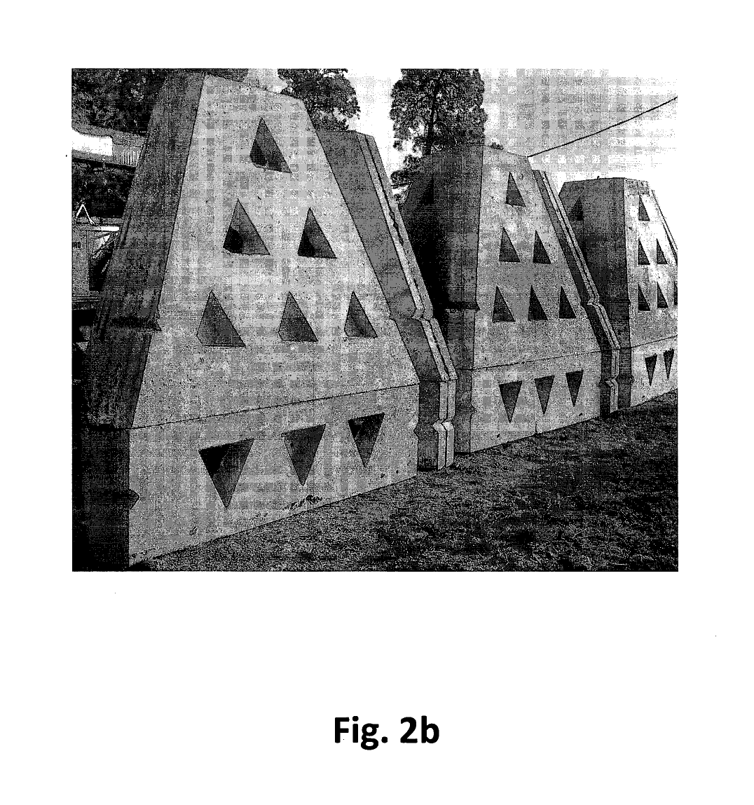

Another illustrative embodiment is shown in FIG. 2. As seen in this figure, artificial reef unit 10b, like the first embodiment, can include side walls 12, an opened bottom 14 and an enclosed top 16. The walls 12 can be sloped inward from the opened bottom 14 to the enclosed top 16. This can give an overall artificial reef shape 10b to be a substantially vertical structure which can include a base larger in size than the top. Such an inclination can provide a design that can provide for a unit that can be transported and stored efficiently, by enabling a subsequent reef to be stacked on top of a preceding reef. For added ease of transportability, a carrying means 20 can be provided on the enclosed top 16. As seen in this figure, the carrying means can include ropes, which can be tied together for forming a loop. This carrying means can enable a fork lift or the like to easily lift and transport the unit 10b to any given location or destination.

In an embodiment, the upward extension of the walls 12 to the enclosed top 16, as seen, can provide opportunity for invertebrates to attach, given the flow pattern around and through the structure. In addition, the structure can help smooth an interaction between the artificial reef and fishing nets, thus helping to prevent snags and entanglements when there is contact.

In an embodiment, the overall structure is such that it can be vertically disposed and provides for a vertical structure. This vertical structure can increase the versatility of the artificial reef 10b. Since the interior of the unit can provide shelter to its inhabitants, the extended vertical height can create an interior that can have varied temperatures at any given level. Such natural temperature variations can offer protection to a wider range of fish species.

In an embodiment, extending through each wall can be at least one opening 26. The opening 26 can be designed and configured to allow for fish life to travel therein and to provide for fluid flow therethrough. Such an arrangement can offer an access means to the interior of the device, which consequently can provide for adequate shelter to the marine life and can also allow for current flow therethrough and prevent stagnant water. The openings can also enable the creation of a habitat for a variety of marine life of differing sizes, and allow easy movement in and out of the structure. In addition, this opening can be of an adequate size so as to allow for light to penetrate therein. The light entering the interior of the artificial reef 10b can provide constant light exposure to micro-nutrient rich water to inherently promote better marine growth.

In an embodiment, the openings and walls, combined, can designed to accommodate hydrodynamic considerations. In an embodiment, the openings and angles of the walls can permit water to flow easily and efficiently therethrough. Water flow or current can travel through the device and not just on or against the device. The action of flowing through an artificial reef can prevent the device from tumbling or tipping over due to turbulent current conditions.

In an embodiment, to aid in the fluid flow and to provide for a smooth transition through artificial reef 10b, each opening 26 can be tapered inward, as seen via reference numeral 28. This tapering 28 can help guide the fluid into and through the artificial reef.

In an embodiment, the upper wall 16 can contact the planar side walls 12. A through hole 30 can extend through upper wall 16 to offer yet another passage for marine life to explore and to allow water to flow therethrough. Such an opening 30 can provide a device that can add stability to artificial reef 10b by permitting fluid flow and reducing upward lifting forces. Through hole 30 can thus prevent current from lifting the structure up and off the bottom. In an embodiment, through hole 30 and enclosed wall 16 can be eliminated to provide for an overall structure with an open bottom and an open top. Such a design can eliminate steps, costs, and material needed to form the overall artificial reef 10b. Moreover, in an embodiment, the vertical structure can be solid.

In an embodiment, to increase the structural strength of the artificial reef 10b, illustrated in FIG. 2, a metallic frame can be embedded therein, as illustrated in outline in FIG. 1. This can provide for each corner to include a vertical support shaft and may optionally include horizontal support shafts.

In embodiments shown in FIGS. 2a and 2b, an artificial reef can include individual modular units positioned or connected to each other at the base. Each unit can be a three-sided pyramid-shaped concrete structure with angled sides and triangular-shaped tapered openings on each side. In an embodiment, units can be placed in a double row array in approximately 4-5 feet of water; parallel to shore and designed such that a wave is actually allowed to transmit through the structures and in doing so, wave energy is significantly reduced.

In an embodiment, a base 31 can be provided for an artificial reef unit 10c to compensate for load factors for placing artificial reef units in poor sediment areas so artificial reef units do not sink into the bottom too much. In an embodiment, a solid base can be retrofitted to the inside of an artificial reef unit to allow for decreased load factors so units can be used in geotechnically challenging areas. This can be cost-effective because bottom preparation materials to support rock and other breakwater structures can be very expensive. In an embodiment, an artificial reef system can be placed in any type of bottom condition.

An embodiment, as shown in FIGS. 2a and 2b, can also include a base or table of suitable material, for example, cement, for an artificial reef that can allow for predictable settling of an artificial reef unit in soft sediments. For example, in many regions of the world, the bottom conditions will not support any structures to remain in place for longer than 2-3 years. In an embodiment, a base 31 can be essentially hollow with a solid bottom that can allow the load (weight) of an artificial reef to be disbursed, lessening the load factor of the structure and allowing it to remain in place for longer period of time without any required maintenance of the system. This exemplary feature can also increase stability of an artificial reef unit by displacing the bottom sediment to reach neutral buoyancy and allowing sediment to migrate inside the base through holes in the side, essentially locking the artificial reef unit in place.

In an example, geotechnical data could show that bottom material of mud and soft peat would not support a load factor over a certain number of pounds per square foot (PSF). An example of conditions when the use of a base can be called for are where soft sediments, e.g., mud, peat, etc., are such that they will not support a load of greater than approximately 165 PSF.

An analysis of geotechnical data of sediment taken from core samples can be used to determine weight, load and expected settlement over a three year period, for example. Displacement and buoyancy factors for the type of water and sediment/mud at a site and predicted settlement of 2.5 feet over three years, for example, can also be analyzed. In order to make the base and the artificial reef unit compatible with the same coverage for wave transmission, the sides of the base can be made vertical, which can allow the artificial reef unit to maintain the same profile, thereby maintaining modeled attenuation.

In an embodiment, a mold for the base can be made of steel, for example, and can be designed such that a solid bottom for the base can be formed. In an embodiment, dimensions for the base can match the bottom dimensions of each site-specific artificial reef unit.

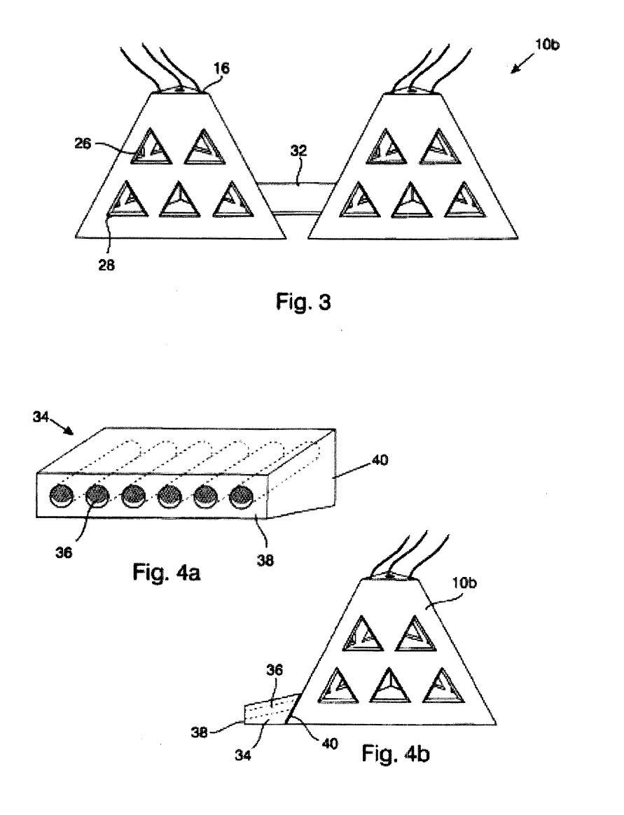

In various embodiments, for example, artificial reef 10a or 10b, as illustrated in FIGS. 1 and 2, can include accessories for broadening the versatility and usability of the artificial reef. One accessory is illustrated in further detail in FIGS. 2 and 3. As seen in these figures, the artificial reef can include shelves 32. The shelves 32 can be located either interiorly (as seen in FIG. 2) or exteriorly (as seen in FIG. 3). In the interior position, the shelves 32 can be connected from opening to opening, connecting and bridging the openings. This arrangement can offer an interesting arrangement and additional habitat and can be desirable to particular species, such as groupers, who prefer overhead shelter. In the exterior arrangement, as seen in FIG. 3, the selves 32 can be used to bridge and couple a series of artificial reefs. The shelves can be made of the same material as the artificial reef. In addition, for more structural stability, each shelf can be reinforced with steel.

For securing the shelves to the openings, conventional attaching means can be used. With the interior arrangement, the self can be added during the fabrication process. Or optionally, in the either arrangements, the selves can include a groove on its underside. This groove can receive the edge of the opening for enabling the shelves to be in a secured and affixed position. Other conventional attaching means can be used, however, for example, screws or the like, for securing the shelves to the artificial reef.

Yet another accessory that can be added to the present invention are bins that can abut an artificial reef. This accessory is illustrated in further detail in FIGS. 4a and 4b. Bin 34 can include a plurality of tunnels 36 extending from the front 38 to the rear 40. The path of the tunnel can be angular, as shown, or straight. The path of the tunnel can extend through the bin horizontally. The rear 40 of the bin 34 can contact the front surface of a particular wall of the artificial reef. In order to provide for an adequate fit, the rear 40 can be angled. The angle can decrease downwardly from the top to the bottom of the bin. This can be opposite from the wall of the artificial reef, providing for a snug and secure fit.

The various unique features of the embodiments of artificial reefs described herein can provide for artificial reefs that can be any size or shape to create a structure that can be designed and configured for a particular environment. Accordingly, the embodiments disclosed herein can be customized to meet a variety of needs. The embodiments described herein can provide a balanced ecological system and can be designed for any particular body of water and for accommodating any species of marine life.

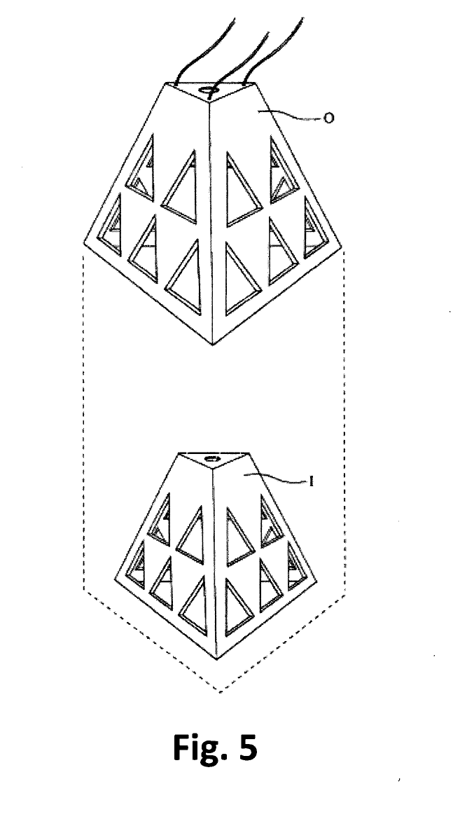

In an embodiment, the openings can also be customized to a particular environment so as to provide for an artificial reef with varied amounts and sizes of openings. For example, the artificial reef shown in FIG. 2 can be changed by eliminating the lower rows of openings. This can provide for the lower portion to imitate mangos. This type of artificial reef can be ideal for use with harvesting shrimp or lobster. In addition, a smaller scale reef can be located within a larger scale reef to add more dimension and interest to the overall structure and consequently provide for a more balanced reef system. This arrangement is shown, for example, in FIG. 5. As seen in this figure, an inner artificial reef I can be located interiorly with respect to an outer artificial reef O.

In an embodiment, the elements and components can be fabricated from steel reinforced concrete to provide for a unit that can be structurally sound and long-lasting, even when exposed to harsh elements. The natural texture of the concrete can help to promote invertebrate growth and enable attachment thereto.

In an embodiment, the stiffest regions of an exemplary artificial reef can lie in the corners. Hence, the corners can include the thickest amount of material, adding to the artificial reef's structural strength and stability. These corners can be reinforced with a frame member.

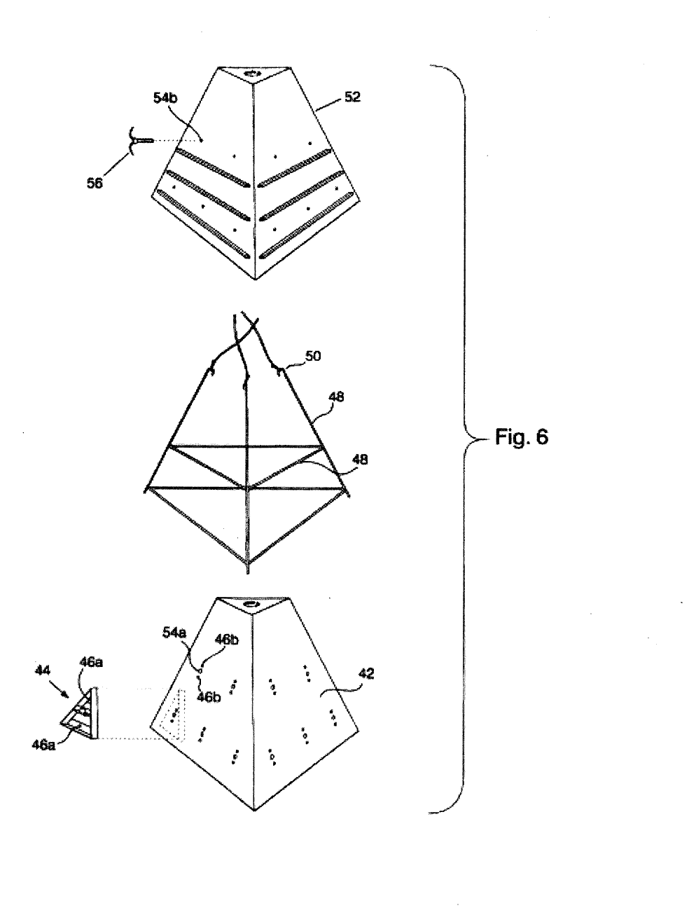

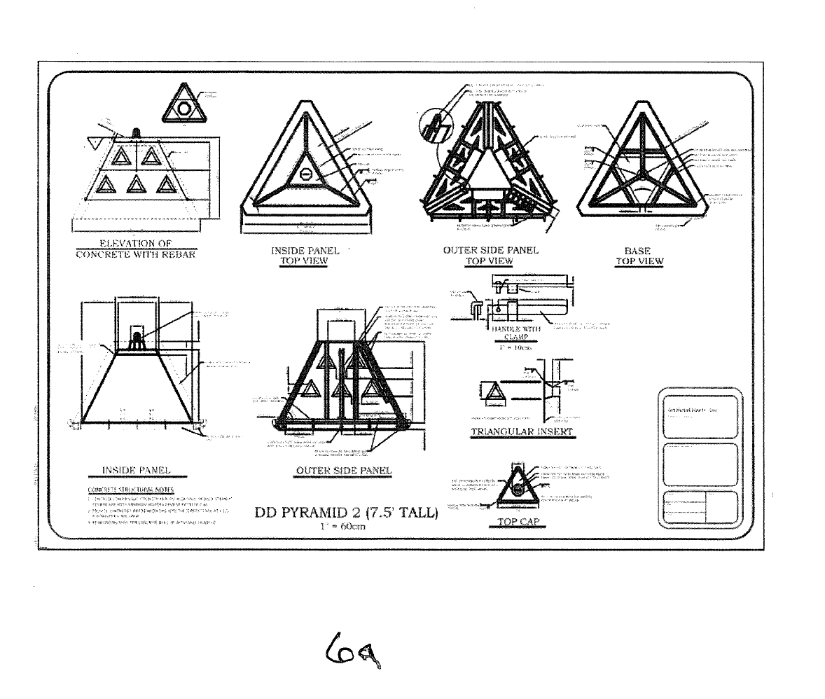

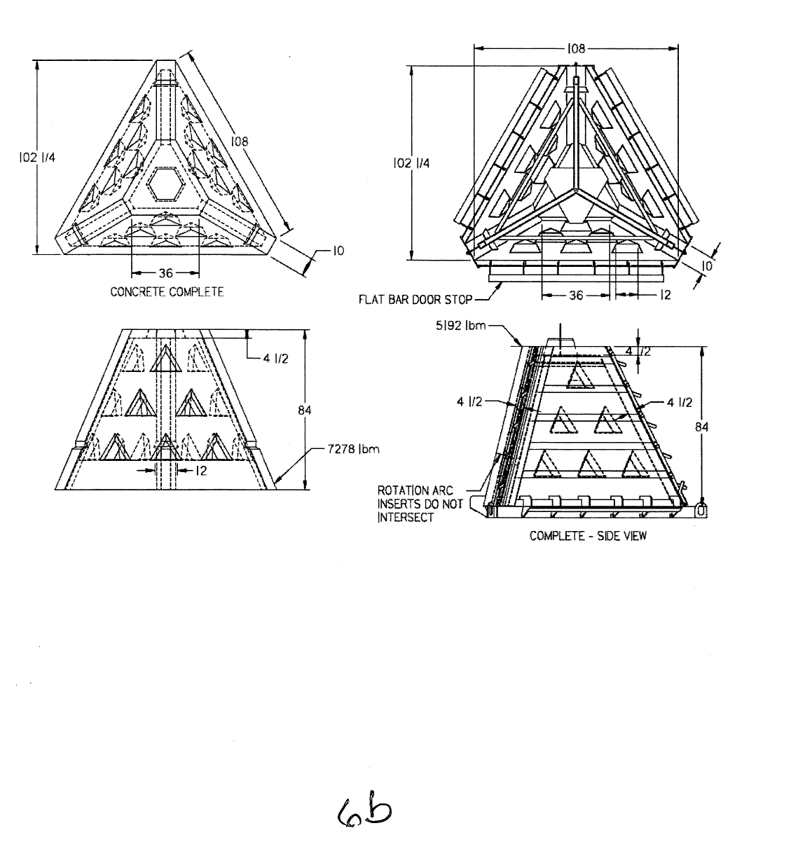

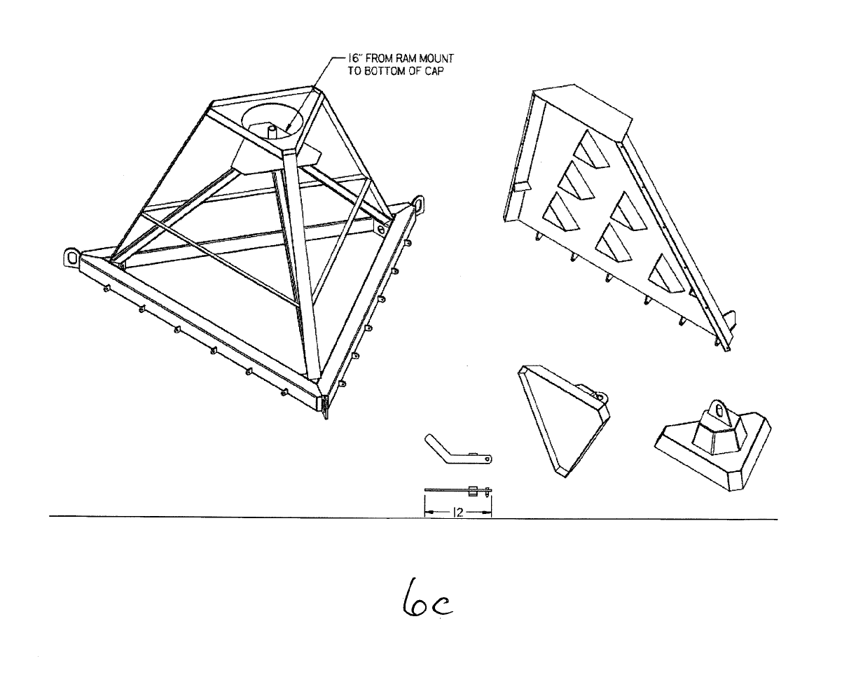

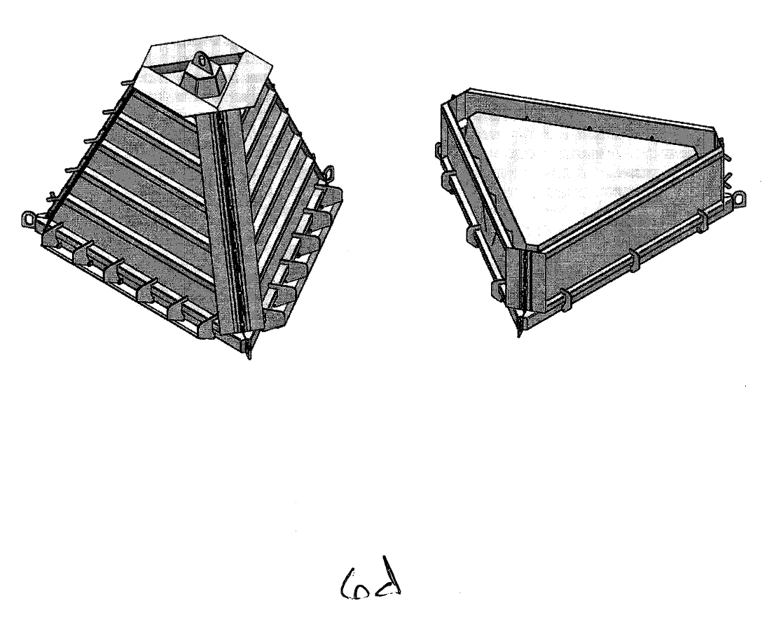

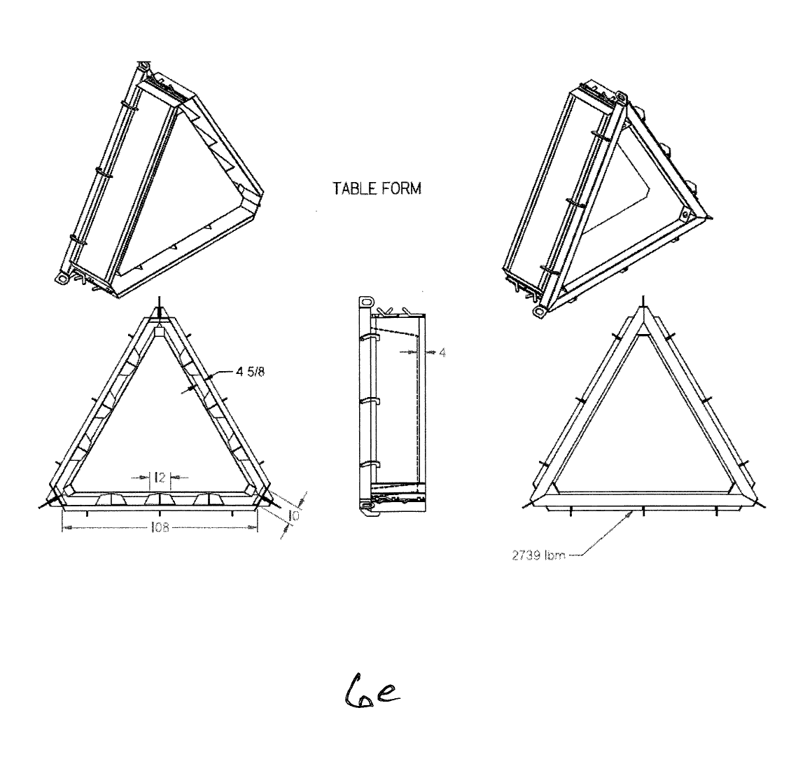

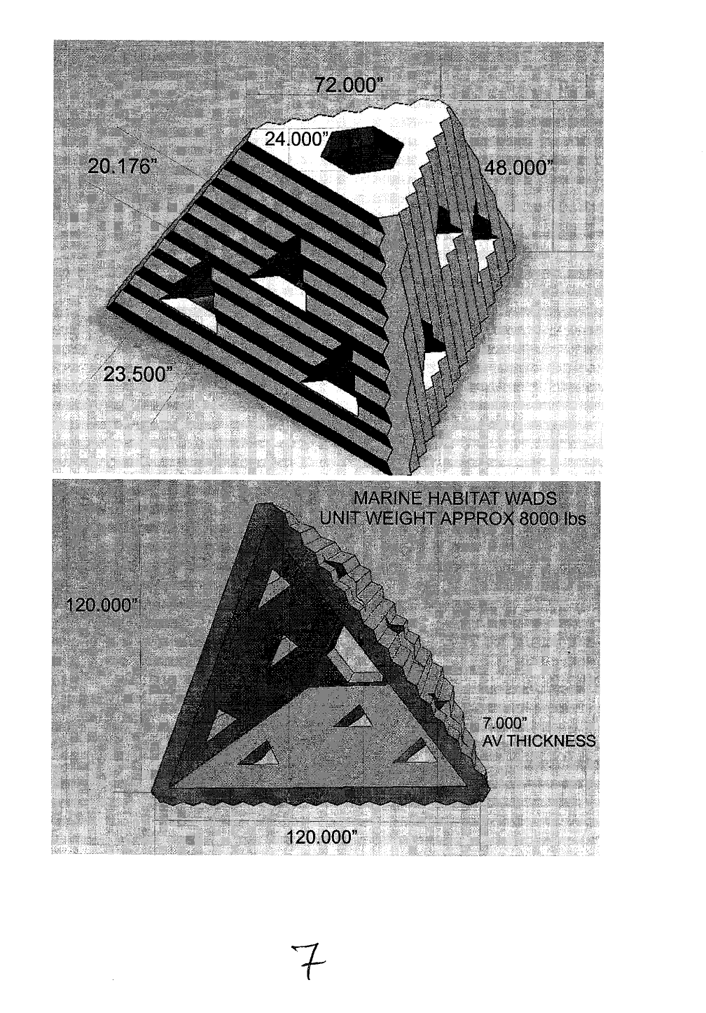

An exemplary method of fabricating an artificial reef is illustrated in further detail in FIG. 6. As seen in this figure, an inner mold 42 can be included. The inner mold 42 can accept a removable hole forming member 44. This hole forming member can includes an attaching means for attaching it to the inner frame. In this embodiment the attaching means can include corresponding apertures 46a and 46b, respectively located in the hole forming member and the inner mold. These holes can be alignable and can be adapted to receive a threadable pin, for example, for providing for the hole forming member to be secured to the inner mold 42.

In an embodiment, surrounding the inner mold 42 can be a structural frame member 48 formed of steel, such as re-bar. A steel member 48 can be located at each corner and optionally, can extend horizontally across each wall member. The horizontal members can be soldered to the vertical members to provide for an integral frame or skeleton. In an embodiment, located at the top of each corner steel member can be a loop or curved portion 50. Secured to this loop or curved portion 50 can be a rope structure, or the like, such as nylon or other material that can be durable and that will not deteriorate in water. For example, polymer cable has been used to produce successful results.

In an embodiment, an outer mold member 52, as seen, can be placed over and around frame 48 and inner mold member 42. A sealing means can secure the inner mold to the outer mold for enabling the hole forming member 44 to contact both the inner mold 42 and the outer mold 52. This can allow for the windows to form. In an embodiment, the sealing means can include threaded apertures 54a located in the inner mold and alignable threaded apertures 54b located in the outer mold 52. A pin 56 or the like can be threadably secured therein to force the outer mold towards the inner mold. This can provide for the hole forming member to be sealed against the inner and outer molds, thereby preventing cement from entering into the area of the hole forming means.

In an embodiment, cement, or the like, can be inserted between the inner and outer molds for forming the artificial reef structures. The cement can extend over the loop or curved members 50 so as to provide a structure where no metal is exposed. Additives can be added to the cement, or the like, for enhancing the structure. During the curing process, such as during warm weather, the cement can be re-wetted for increasing the strength of the final structure. Once the cement is cured, the outer mold can be remove; the hole forming members can be removed; and the formed artificial reef can be removed. The design and configuration of the structure can provide for an artificial reef that can stacked, rendering a compact and efficient mode of transporting and storing the finished reef structures.

Improved clamshell form/mold system allowing adjustable height artificial reef units for different site applications. In an embodiment, a simple three or more-sided mold system that can be hinged at the bottom can allow the sides to rotate out with the opening boxes attached to the outer wall. Referring to FIGS. 6a-6e,in an embodiment, a solid inner mold with a detachable inner cap can allow a concrete-poured artificial reef unit to be pushed up from inside by a mounted jack, for example, and thus easily lifted from the form. Due to the method of lifting the artificial reef unit up from the form, no rebar is required for artificial reef unit structural integrity. In an embodiment, the ability to easily rotate side panels out with tapered opening forms attached allows an artificial reef unit to be aired and cured faster, allowing the form to produce two to three units per day, for example, decreasing production time.

In an embodiment, artificial reef forms can be relatively easily resized by adding outer panels to both inner and outer panel to make different size artificial reef units. This can allow one form/mold system to be used for multiple jobs without making many different forms, saving money and resources.

Corrugation design for increased attenuation.

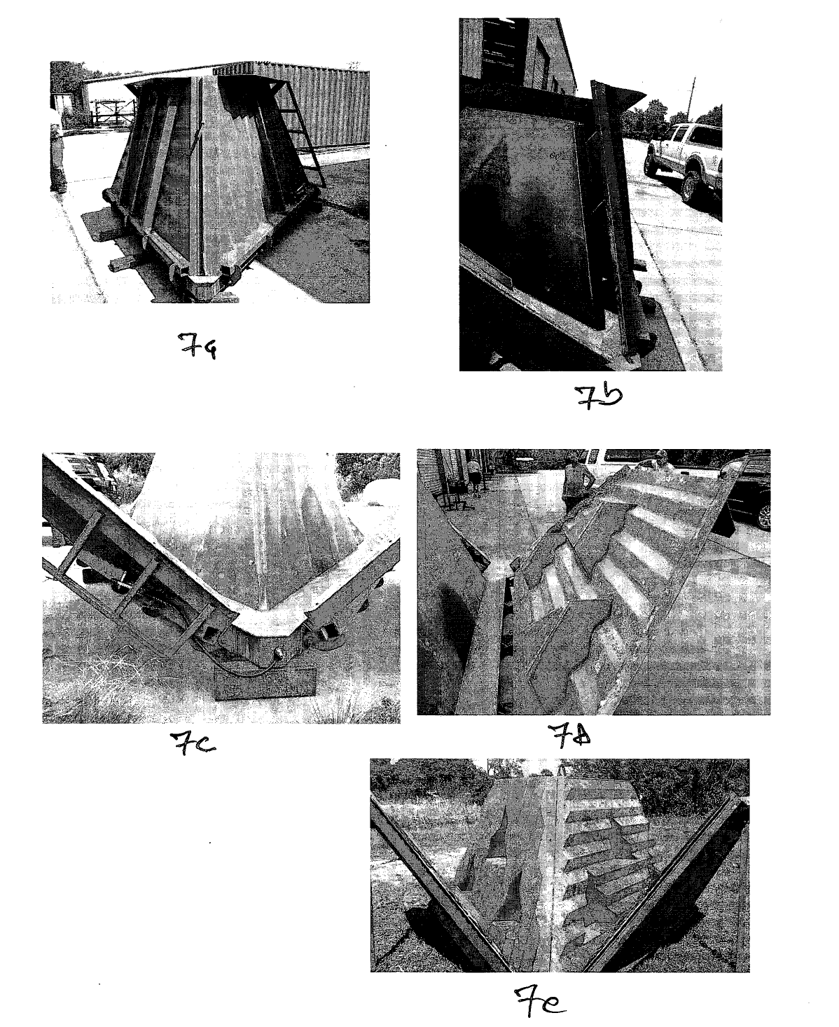

Known artificial reefs with smooth-sided walls can require a higher vertical profile and base-to-base alignment in a double row for maximum attenuation. In embodiments shown in FIG. 7, a small horizontally-aligned corrugation on a side of an artificial reef facing the wave energy can better deflect the wave energy in a horizontal direction along (sideways) an artificial array, and a small vertically-aligned corrugation on one or more of the remaining sides can greatly increase energy attenuation, i.e., reduce the energy, as it transmits through an artificial reef array. Corrugation, as understood here, typically means alternating ridges and grooves, typically in parallel. This can allow artificial reef units to be spaced further apart, thus using less material. In an embodiment, artificial reef units with appropriate corrugation can achieve the same attenuation goals, but at a reduced cost, e.g., less product used for construction can mean less cost to manufacture and install. This can mean greater shoreline protection using fewer artificial reef units, making the corrugation design even more cost effective.

In an embodiment, the corrugations can be structured with a 2.5 flat with 1.5-2.0 relief (numbers in inches). These numbers can be varied to achieve desired results while still not departing from the scope of the disclosed embodiments.

In an embodiment, while corrugation can allow for greater attenuation of wave energy and can allow artificial reef units to be spaced farther apart, tapered design openings in artificial reef units can also increase/decrease velocity of wave fluid.

In an embodiment, at least one tapered opening on a side facing wave energy can be provided. An opening tapered inwardly to increase water velocity going inside the artificial reef unit and decrease wave pressure can provide greater stability and allow an artificial reef unit to be submerged and shoot wave energy out through an opening in the top of an artificial reef unit to impact wave energy rolling over an artificial reef unit, attenuating the wave energy. The wave energy inside an artificial reef unit can now be directed out the remaining sides with at least one opening, each with outwardly tapered openings to decease wave velocity and increase pressure by a factor of approximately at least 2, for example. This can attenuate the energy as the wave transmits through the artificial reef array, allowing sediment suspended in the wave fluid to fall to the bottom, shoreward of the artificial reef array, naturally rebuilding the beach without having to dredge and artificially rebuild the beach, and possibly saving millions of dollars in coastal restoration work every year.

In an embodiment, a purpose of an artificial reef array is to attenuate wave energy and slow the energy of the waves so that any sediment being carried in the wave fluid is released shoreward of an artificial reef array. It allows the wave to transmit through the artificial reef array, which over time becomes a natural barrier reef productive with marine life and natural corals that can further attenuate the wave energy and becomes a natural barrier reef system in a matter of a few years, unrecognizable as a man-made structure. This can result in restoring and protecting the world's coastal shorelines. Artificial reef units are not only stable and durable, but also portable. They can be designed without anchoring devices to successfully withstand hurricanes to Category 5 and to be adjusted or repositioned, i.e., portable.

For deploying an artificial reef, a plurality of reef units can be stacked. This convenient stacking method can provide a way of transportation that can be efficient and that can provide a structure that will minimize the use of valuable space. This stacking ability can provide a structure that can enable transportation over land and by sea that can be less costly and more productive, by allowing more items to be shipped using less room than known artificial reefs. Each artificial reef structure can be carefully placed using, for example, a crane, to help ensure it is placed in its proper place, for example, a predetermined position. In an embodiment, the artificial reef can be relatively easily moved before, during and after deployment through a built-in carrying or lifting means 20, as previously discussed. The structure can be moved without touching, disturbing or disrupting other artificial reef units or other structures, for example, a natural reef. This carrying means can be used so that the environment that any marine life that has developed can remain relatively undisturbed through transportation.

Artificial reef unit alignment and spacing options.

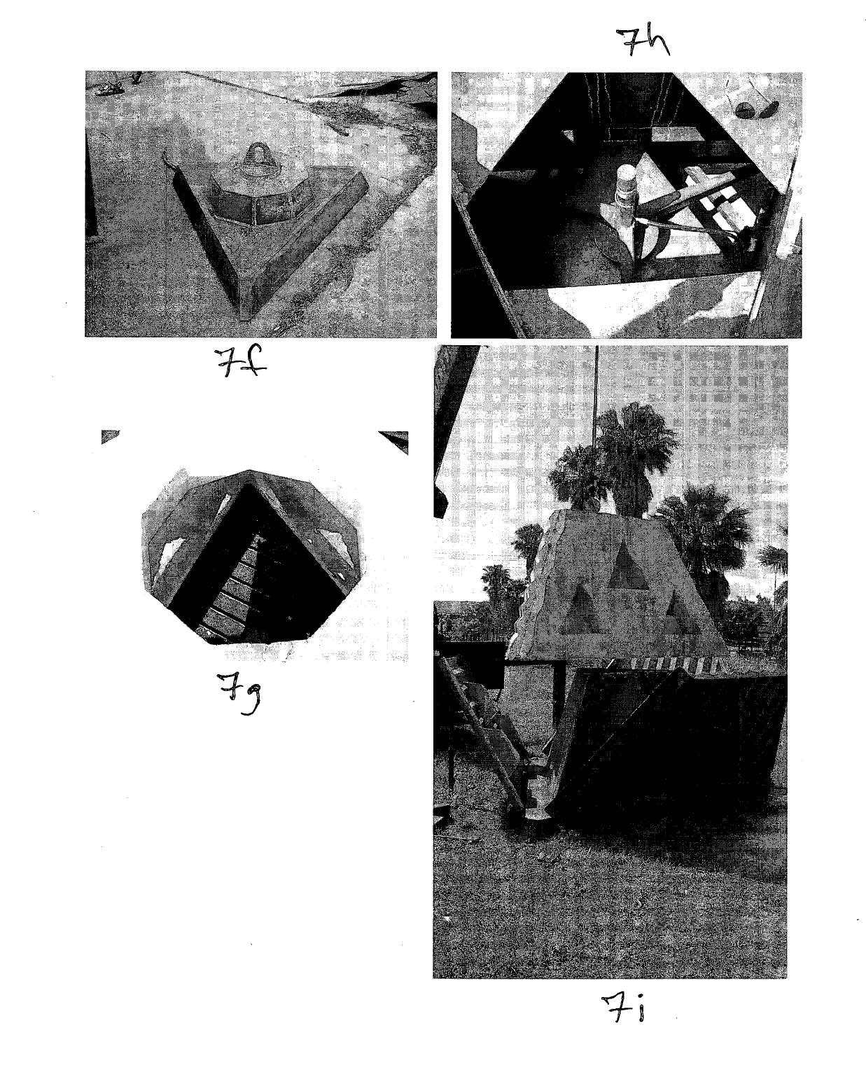

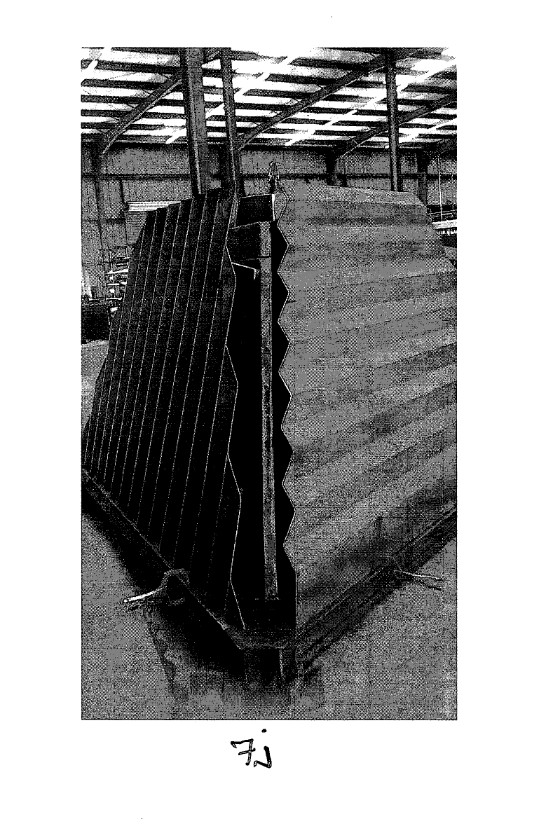

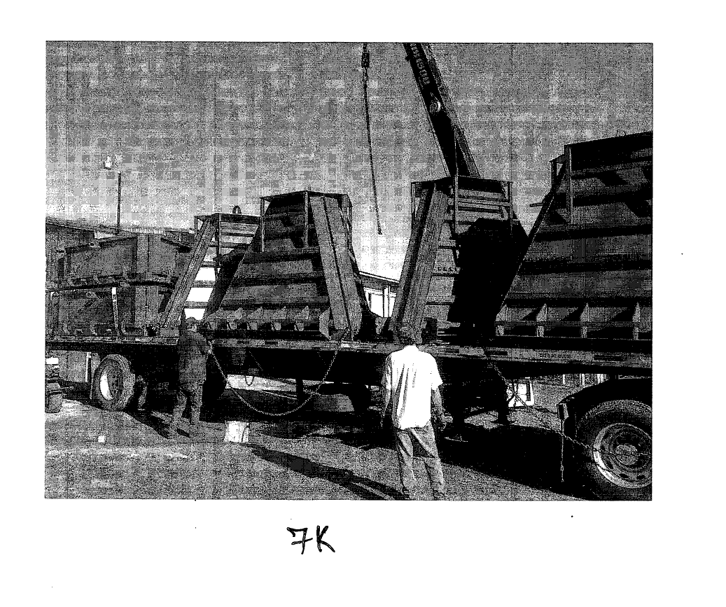

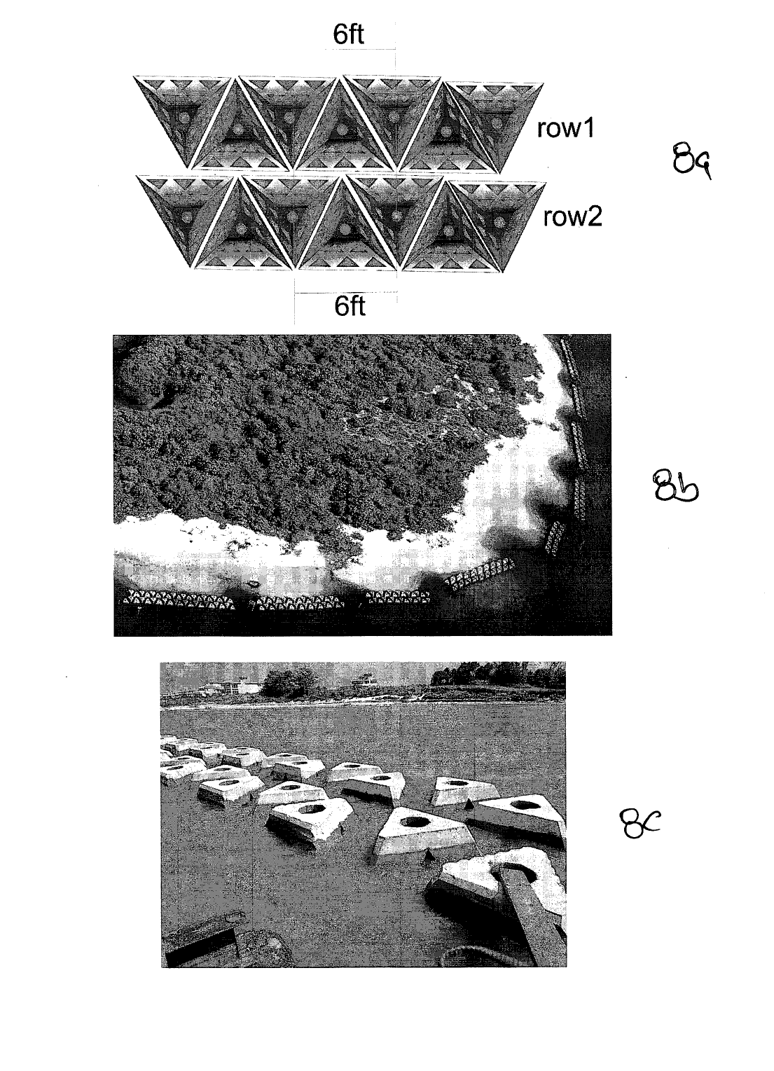

Referring to FIG. 8, in an embodiment, artificial reef units can be aligned base-to-base in a continuous reef, also referred to as an array, parallel to shore and may be angled in to shore at the ends of the array. The array can comprise two lines of reef arrays offset so that the wave energy can be redirected as the wave transmits through the array, further attenuating or reducing wave energy.

Segmented artificial reef arrays can also be designed to cover more shoreline, more cost-effectively, and to allow recreational access to the shoreline for humans and marine life.

In an embodiment, arrays of artificial reefs can be designed to align parallel to shore and curved in towards the shore at the ends of the array. This can provide coastal protection up-current and down-current of the array so as not to negatively impact littoral drift and sand transport, unlike present day groins and breakwaters. This arrangement can provide increased accretion of sand on either side of the array and up to 200 meters away. This is in contrast to rock jetties and breakwaters, which can have a negative impact on adjoining shorelines, such as eroding the shore and causing adjacent landowners to purchase protection for the shoreline.

In an embodiment, artificial reef units can be repositioned very cost effectively. A beach can be naturally rebuilt out to an original artificial reef array and the array can then be repositioned to accrete even more beach after units are moved further offshore.

Interlocking artificial reef application for infrastructure protection. In an embodiment, artificial reefs can be designed with a vertical back wall with an interlocking key to form a curving or straight vertical wall with at least the other two walls acting in a wave attenuating capacity. This way they can be an integral part of the infrastructure.

Artificial reef array planning and design process.

Once an erosion problem has been identified, a physical site survey can be conducted. Survey items can include observed bathymetric conditions and observed beach/shoreline conditions. A geotechnical analysis of bottom sediments in the area can be conducted, including analyzing data obtained from testing and borings.

An historical analysis over a 20-100 year period of wind and waves and storm events can be conducted. That data can be used with bathymetric xyz data in a computer model, for example, that can be run using, for example, four or more iterations of artificial reef array configurations/locations, and then run to determine best placement and maximum wave energy attenuation. Factors to be considered can also include requirements to have the artificial reef units visible above the water line or submerged, and level of acceptable attenuation rates (e.g., 98% vs. 70%). Sufficient room for swimming and recreational access with boats and jet skis, etc., can be taken into account in the design process. Once the modeling is complete, the results can be evaluated and used to design individual artificial reef units and an artificial reef array or arrays. Artificial reef unit form engineering drawings for the steel for fabrication can be created.

In an embodiment, once the forms are made and shipped to a work site, the individual artificial reef units can be constructed. Once complete, the artificial reef units can be loaded onto a barge, for example, and transported to an artificial reef site and placed in the water according to the planned design. A survey and “as-built” evaluation can then be performed and the site can be monitored for a period of time, for example, two years. If any adjustments need to be made, artificial reef units can be adjusted or replaced, or if they have accreted sufficient shoreline, for example, out to the artificial reef units and a need for more shoreline exists, the artificial reef units can be moved further to seaward.

The above description is presented to enable a person skilled in the art to make and use the systems and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. An artificial reef unit, comprising:
a lower portion and an upper portion; the lower portion is larger in size than the upper portion to provide for an gradual decrease in surface area from the lower portion to the upper portion;
at least one wall extends from the lower portion to the upper portion forming an enclosure, wherein at least one opening extends through the enclosure;
an enclosed top wall is located at the upper portion; the at least one wall is fabricated from a water impervious material and the at least one wall is substantially textured and is free from obstructions; the at least one wall forms an artificial reef having an integral structure and including a substantial weight for maintaining the at least one wall in an upright and balanced position when in a body of water; and
a hollow base portion with vertical sides and a solid bottom upon which the lower portion sits.

2. An artificial reef unit as in claim 1 wherein the enclosure is hollow.

3. An artificial reef unit as in claim 1 wherein the enclosure comprises at least three side walls.

4. An artificial reef unit as in claim 1 wherein the impervious material is concrete.

5. An artificial reef unit, comprising:
a lower portion and an upper portion; the lower portion is larger in size than the upper portion to provide for an gradual decrease in surface area from the lower portion to the upper portion;
at least one wall extends from the lower portion to the upper portion forming an enclosure, wherein at least one opening extends through the enclosure; and
an enclosed top wall is located at the upper portion; the at least one wall is fabricated from a water impervious material and the at least one wall is corrugated; the at least one wall forms an artificial reef having an integral structure and including a substantial weight for maintaining the at least one wall in an upright and balanced position when in a body of water.

6. The artificial reef unit of claim 5, further comprising a hollow base portion with vertical sides and a solid bottom upon which the lower portion sits.

7. The artificial reef unit of claim 5 wherein the enclosure is hollow.

8. The artificial reef unit of claim 5 wherein the enclosure comprises at least three side walls.

9. The artificial reef unit as in claim 5 wherein the impervious material is concrete.
